(19) United States
(12) Patent Application Publication
(10) Pub. No.: US 2020/0343938 A1
(43) Pub. Date: Oct. 29, 2020

(54) Frequency Hopping for a Random Access Preamble

(71) Applicant: Telefonaktiebolaget LM Ericsson (publ), Stockholm (SE)

(72) Inventors: Gerardo Agni Medina Acosta, Märsta (SE); Talha Khan, Santa Clara, CA (US); Olof Liberg, Stockholm (SE); Yutao Sui, Solna (SE)

(21) Appl. No.: 16/963,010

(22) PCT Filed: Feb. 6, 2019
(86) PCT No.: PCT/SE2019/050100

§ 371 Date: Jul. 17, 2020

Related U.S. Application Data
(60) Provisional application No. 62/627,171, filed on Feb. 6, 2018.

(51) Int. Cl. H04B 1/7143; H04W 74/08; H04L 27/26

(52) U.S. Cl. CPC H04B 1/7143; H04L 27/2607; H04W 74/0833

(57) ABSTRACT

Methods and apparatus for random access in a TDD NB-IoT system are provided to enable frequency errors at the user equipment and/ or base station to be accounted for, e.g., when determining time alignment or timing advance. In one embodiment, for example, the frequency hopping between symbol groups comprising the preamble enables the recipient of the random access preamble to cancel, nullify, or otherwise mitigate phase errors attributable to such frequency errors. This is achieved by transmitting a random access preamble with frequency hopping symbol groups one or more times using, wherein frequency hopping between the symbol groups includes at least a first upward hop by a first frequency distance, a first downward hop by the first frequency distance, a second upward hop by a second frequency distance different than the first frequency distance, and a second downward hop by the second frequency distance, wherein the random access preamble comprises multiple symbol groups, wherein each symbol groupcomprises a cyclic prefix followed by one or more symbols.

### TECHNICAL FIELD

The present disclosure relates generally to random access procedures for accessing a wireless communication network and. more particularly, to a random access procedures using frequency hopping for preamble transmission.

### BACKGROUND

In a wireless communication system, a user equipment may need to initiate a data transfer to the network (via a base station) without already having been assigned uplink resources. To handle this, a random access procedure is available where a user equipment that does not have a dedicated uplink resource may nevertheless transmit a signal to the base station. The first message of this procedure is typically transmitted on a special resource reserved for random access, i.e., a physical random access channel (PRACH).

That said, a random access procedure can be used for a number of different reasons. These reasons include: initial access, such as for user equipment in idle (RRC_IDLE) states; incoming handover; resynchronization of a user equipment; transmission of a scheduling request, such as for a user equipment that is not allocated any other resource for contacting the base station or that has sent the base station a maximum allowed number of scheduling requests without any response from the base station.

Regardless, a user equipment may initiate the random access procedure by randomly selecting one of several preambles available, and then transmitting the selected random access preamble on the physical random access channel (PRACH). The network may acknowledge any preamble it detects by transmitting a random access response; this random access response may include an initial grant of resources to be used on the uplink shared channel, and a time alignment (TA) or timing advance update based on the timing offset of the preamble measured by the network. After receiving the random access response, the user equipment may use the resources specified in the uplink grant to transmit a message that in part is used to trigger the establishment of radio resource control and in part to uniquely identify the user equipment on the common channels of the cell. The timing alignment command provided in the random access response may be applied in this uplink transmission. For contention-based access, the procedure may end with the network resolving any preamble contention that may have occurred in the event that multiple user equipments transmitted the same random access preamble at the same time.

Under some circumstances, though, such as in a narrowband internet of things (NB-IoT) time division duplexing (TDD) system, frequency errors at the user equipment and/or base station risk biasing or otherwise negatively impacting the time alignment determined from the random access procedure.

### SUMMARY

Certain aspects of the present disclosure and their embodiments may provide solutions to these or other challenges. Some embodiments for example provide frequency hopping for a random access preamble that enables frequency errors at the user equipment and/or base station to be accounted for, e.g., when determining time alignment or timing advance. In one embodiment, for example, the frequency hopping enables the recipient of the random access preamble to cancel, nullify, or otherwise mitigate phase errors attributable to such frequency errors.

Embodiments include a method performed by a wireless device. The method may comprise transmitting a random access preamble one or more times using frequency hopping. The frequency hopping used to transmit the random access preamble each of the one or more times includes at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise one or more symbols.

Embodiments also include a method implemented by a radio network node. The method may comprise receiving from a user equipment a random access preamble one or more times using frequency hopping. The frequency hopping used to receive the random access preamble each of the one or more times may include at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise one or more symbols.

Some embodiments for example provide a method for a “frequency hopping” design for a narrowband PRACH (NPRACH) in TDD NB-IoT that is resistant to frequency errors. In some embodiments, for example, the frequency hopping patterns for NPRACH in TDD NB-IoT are formed from configurable and/or predefined tone indexes (including 3.75 kHz and 22.5 kHz hopping distances) selected to partially or fully cancel out phase errors within one single NPRACH preamble repetition unit (also referred to simply as one single NPRACH preamble). In one embodiment, for example, the frequency hopping patterns are configured to pairwise hop upwards (+3.75 or +22.5 kHz) and downwards (−3.75 or −22.5 kHz). By ensuring that phase error cancellation can be performed within a single NPRACH preamble repetition unit, the NPRACH transmission may be confined in time to the maximum extent possible which makes the transmission less prone to frequency errors.

In some embodiments, the frequency hopping patterns for NPRACH in TDD NB-IoT have a hopping distance for every symbol group composing one NPRACH preamble repetition unit, where the hopping distances associated to the symbol groups can be equal or different, predetermined and/or configurable.

According to some embodiments, for the support of NPRACH for TDD NB IoT, a frequency hopping design is presented where the hopping distances associated to the symbol groups composing an NPRACH preamble repetition unit can be equal or different, predetermined and/or configurable. The configurable and/or predefined tone indexes (including 3.75 kHz and 22.5 kHz hopping distances) can be selected to cancel out phase errors within a sole NPRACH preamble repetition unit. That is, the symbol groups can be made to hop upwards and downwards nullifying each other for canceling phase errors within an NPRACH preamble repetition unit.

Certain embodiments may provide one or more of the following technical advantage(s). A frequency hopping design for NPRACH in TDD NB-IoT with configurable and/or predefined hopping distances (including 3.75 kHz and 22.5 kHz) can be used to cancel out frequency and phase errors at the eNB when processing the received NPRACH signal within one NPRACH preamble repetition unit (i.e., the phase errors caused by a frequency error nullify each other when hopping upwards and downwards within one NPRACH preamble repetition unit) rather than having to wait for the next NPRACH preamble repetition unit transmission to cancel out the phase errors. Alternatively or additionally, cancelling phase errors within an NPRACH preamble repetition unit avoids the need of having to introduce a conditional hopping, which involves the transmission of at least two preamble repetition units to obtain the frequency and phase error cancelation. Alternatively or additionally, the ability of cancelling frequency and phase errors within an NPRACH preamble repetition unit makes the performance robust towards drifting frequency errors, especially in TDD configurations where there is only one uplink subframe available per radio frame (e.g., TDD configuration #5), in which case (i.e., depending on the NPRACH preamble format) the frequency and phase error cancelation could take up to two radio frames, while if the frequency and phase error cancelation depends on the transmission of two adjacent NPRACH preamble repetition units then the phase error cancellation could take up four radio frames. Alternatively or additionally, the ability of cancelling frequency and phase errors within an NPRACH preamble repetition unit might result in reducing the number of required repetitions, since the frequency and phase error cancelation is achieved earlier.

### BRIEF DESCRIPTION OF THE FIGURES

FIG. 1 illustrates an exemplary communication network employing frequency hopping for random access as herein described.

FIG. 2 illustrates a random access procedure.

FIG. 3 illustrates a random access frequency hopping symbol group of length 1.4 or 1.6 ms.

FIG. 4 illustrates random access frequency hopping where a symbol group is 1.6 ms long.

FIG. 5 illustrates two repetitions of a random access NPRACH preamble repetition unit.

FIG. 6 illustrates a NPRACH preamble repetition unit in FDD compared to the NPRACH preamble repetition unit in TDD.

FIG. 7 illustrates an exemplary embodiments of a frequency hopping random access as herein described.

FIG. 8 depicts a method performed by a wireless device configured to perform frequency hopping random access as herein described.

FIG. 9 depicts a method performed by a radio network node configured to perform frequency hopping random access as herein described.

FIG. 10 depicts another method performed by a wireless device configured to perform frequency hopping random access as herein described.

FIG. 11 depicts another method performed by a radio network node configured to perform frequency hopping random access as herein described.

FIG. 12 depicts another method performed by a wireless device configured to perform frequency hopping random access as herein described.

FIG. 13 depicts another method performed by a radio network node configured to perform frequency hopping random access as herein described.

FIG. 14 for example illustrates a wireless device configured to perform frequency hopping random access as herein described.

FIG. 15 illustrates a schematic block diagram of a wireless device configured to perform frequency hopping random access as herein described.

FIG. 16 illustrates a radio network node configured to perform frequency hopping random access as herein described.

FIG. 17 illustrates a schematic block diagram of a network node in a wireless network configured to perform frequency hopping random access as herein described.

FIG. 18 illustrates an exemplary wireless network according to an embodiment.

FIG. 19 illustrates an exemplary UE according to an embodiment.

FIG. 20 illustrates an exemplary virtualization environment according to an embodiment.

FIG. 21 illustrates an exemplary telecommunication network connected via an intermediate network to a host computer according to an embodiment.

FIG. 22 illustrates an exemplary host computer communicating via a base station with a user equipment over a partially wireless connection according to an embodiment.

FIGS. 23-26 illustrate an exemplary methods implemented in a communication system, according to an embodiment.

### DETAILED DESCRIPTION

Referring now to the drawings, an exemplary embodiment of the disclosure will be described in the context of a NB-IoT communication network 10 that employs repetition and frequency hopping for preamble transmission. This new radio access technology provides connectivity to services and applications demanding qualities such as reliable indoor coverage and high capacity in combination with low device complexity and optimized power consumption. Release 13 of the NB-IoT standard supported only frequency division duplexing (FDD) operation. Release 15 introduces support for time division duplex (TDD) mode of operation. The communication network 10 as herein described may be a time division duplex (TDD) system or otherwise operate according to TDD. Those skilled in the art will appreciate that the methods and apparatus herein described are not limited to use in NB-IoT networks, but may also be used in other types wireless communication networks 10 where repetition and frequency hopping are used for preamble transmission.

The communication network 10 includes a radio network node 12 (also referred to as radio network equipment, e.g., an eNB) and a wireless device 14 (e.g., a user equipment, which may be a NB-IoT device). The device 14 is configured to perform random access, e.g., for initial access when establishing a radio link, for transmitting a scheduling request, and/or for achieving uplink synchronization. Regardless of the particular objective achieved by this random access, the device 14 transmits a random access channel transmission 16 to the radio network node 12 as part of random access. Where the communication network 10 is a NB-IoT system, for instance, the device 14 may transmit the random access channel transmission over a narrowband physical random access channel (NPRACH) (e.g., according to TDD), such that the random access channel transmission 16 is an “NPRACH transmission” in NB-IoT. The network node 106, if it receives the preamble message or transmission 110, can transmit signaling 112 via a random access response (RAR), to the wireless device 14, which can include an uplink time-frequency resource grant for transmission of a connection request message transmitted by the UE.

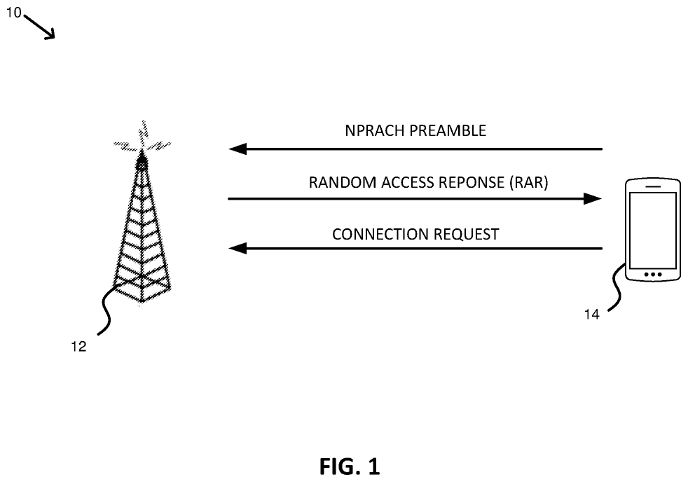

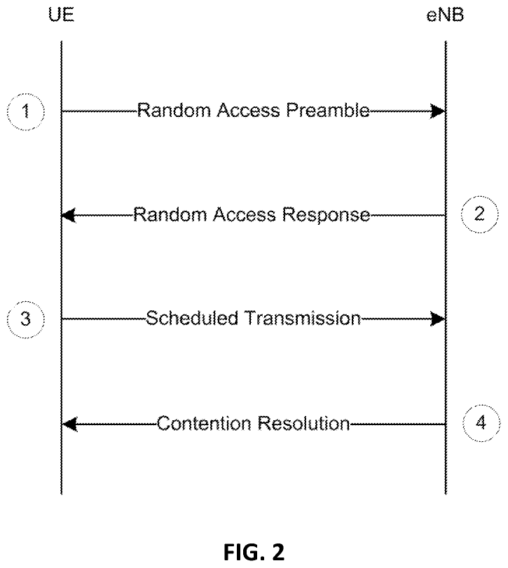

FIG. 2 illustrates an example random access procedure performed in the system 10 of FIG. 1. As illustrated, the random access procedure includes a message 1 whereby the UE 102 transmits a random access preamble, a message 2 which includes the time-frequency grant for a scheduled connection request in message 3, and ultimately, some contention resolution message 4 that indicates whether connection is successful or whether further random access procedure attempts are needed.

NB-IoT uses repeated transmissions of the preamble to extend its coverage compared to earlier supported 3 GPP radio access technologies. When accessing the system, a wireless device 14 may for example repeat the Narrow Band Random Access Channel (NPRACH) preamble transmission up to 128 times to achieve coverage in the most demanding situations. As used herein, the term “repetition” is used to refer to each preamble transmission, including the first transmission.

In NB-IoT, the random access procedure (RA) provides means of synchronization to the uplink frame structure. A device initiates the RA procedure after synchronizing to the downlink frame structure. In the first step of the RA process a device transmits a preamble. In the second step the eNB detects the preamble time of arrival (TA) and signals the TA value to the UE. The UE will thereafter use the TA value to align its transmission to the UL frame structure.

FDD NPRACH Waveform

The physical layer random access preamble is based on single-subcarrier frequency-hopping symbol groups. A symbol group consists of a cyclic prefix (CP) and a sequence of 5 identical symbols. The preamble consisting of 4 symbol groups transmitted without gaps shall be transmitted Nᵣₑₚ^{NPRACH} times. Each symbol corresponds to an unmodulated sinus wave of frequency 3.75 kHz and periodicity 8192 Tₛ=266 μs, where Tₛ equals 1/(15000×2048) s. The preamble is transmitted over a 3.75 kHz channel. Two CP lengths are supported, i.e. 66 us (Format 0) and 266 us (Format 1). For the 266 μs choice, the CP is identical to a symbol.

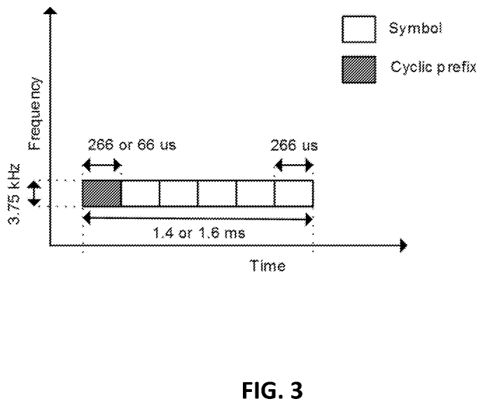

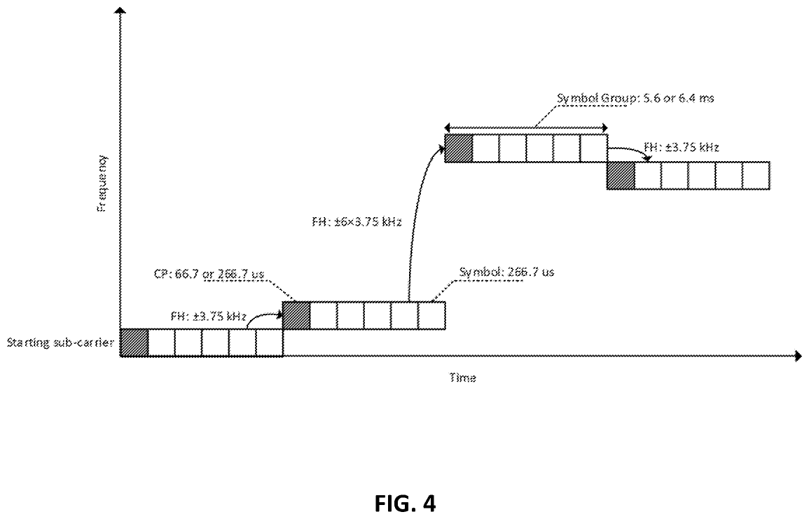

The NB-IoT FDD minimum system bandwidth of 180 kHz is dividable in totally 48 sub-carriers, or tones, each 3.75 kHz wide. For a single FDD NPRACH transmission, the symbol group of FIG. 3 is hopping four times across at most seven sub-carriers as shown in FIG. 4. This physical signal, also called a NPRACH preamble repetition unit, is uniquely defined by the first sub-carrier in the hopping pattern, i.e. the starting sub-carrier. In total 48 orthogonal preambles can be defined, one for each available starting sub-carrier.

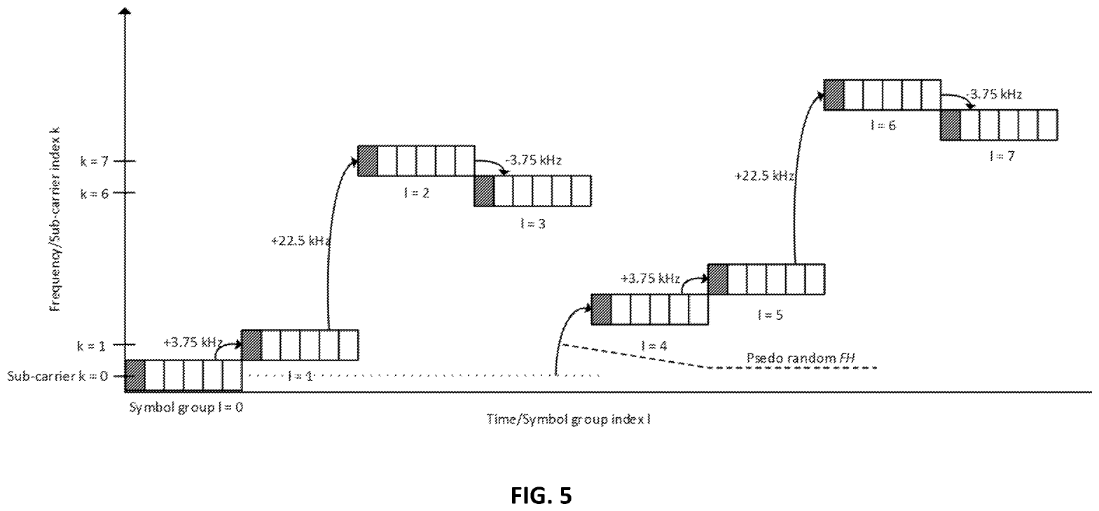

To support higher levels of coverage, a coverage extension (CE) level may be associated with up to 128 repetitions of the random access frequency hopping symbol group. A pseudo random frequency hop is used between the basic preamble transmission units as illustrated in FIG. 5. The pseudo random frequency hop is bounded so that the NPRACH transmission never spans more than 12×3.75=45 kHz. Also, the direction of the large frequency hop in the repetition is restricted to secure that the NPRACH transmission never spans more than 12×3.75=45 kHz. In this example, both the first and second frequency hopping symbol group is using the same hopping direction when making the large 22.5 kHz hop.

At the device transmitter the NPRACH waveform at symbol group l, time t and subcarrier k can be described as:

s₁(t, k)=e^{j2πkΔF(t-T}_{CP}) Eq. (1)

where ΔF equals the subcarrier spacing of 3.75 kHz, T_{CP} the time duration of the cyclic prefix which we here for simplicity can fix at 266 us, and the time t is defined over a symbol group, i.e. 0≤t≤T, where T=6×266 us.

If, for simplicity, assuming that the radio channel is stationary with unity gain, and a device with a perfect frequency reference, then at the base station (BS) receiver the NPRACH symbol group waveform can, after the cyclic prefix removal, be described as:

r₁(t, k)=e^{j2πkΔF(t-D)} Eq. (2)

where D equals the time of arrival relative the UL radio frame structure, or in other words the round-trip time which equals twice the propagation delay due to the distance between the device and the BS. Since this is after removal of the cyclic prefix, the time tis in the received side defined for 0≤t≤T−266 us.

By correlating two consecutive symbol groups rₙ(t, k) and rₙ₊₁(t, k+1) the BS can detect and determine the delay D. For simplicity, assume n=0, k=1 and t=0.j The correlation then gives:

r₀(0, 1)·r₁*(0, 2)=e^{-j2π2ΔFD}=e^{j2πΔFD} Eq. (3)

The argument, or angle, of the complex correlation metric, can in a second step be used to determine the delay D.

$$\begin{matrix}arg ( {r}_{0} ( 0 , 1 ) \cdot {r}_{1}^{*} ( 0 , 2 ) ) = {φ}_{01} = 2 πΔ FD & Eq . ( 4 ) \\ D = \frac{{φ}_{01}}{2 π Δ F} = \frac{{φ}_{01}}{2 π \cdot 3.75 \cdot {10}^{3}} & Eq . ( 5 )\end{matrix}$$

Likewise when correlating symbols across the larger frequency hop of 22.5 kHz then the delay D is estimated as:

$$\begin{matrix}arg ( {r}_{1} ( 0 , 1 ) \cdot {r}_{2}^{*} ( 0 , 7 ) ) = {φ}_{12} = 2 π 6 Δ FD & Eq . ( 6 ) \\ D = \frac{{φ}_{12}}{2 π 6 Δ F} = \frac{{φ}_{12}}{2 π \cdot 22.5 \cdot {10}^{3}} & Eq . ( 7 )\end{matrix}$$

The intention of the small frequency hop of 3.75 kHz is to facilitate detection of a delay up to 266 us corresponding to a cell range of 40 km. The intention of the large frequency hop of 22.5 kHz is to facilitate detection with fine timing granularity.

FDD NPRACH Time of Arrival Estimation in Presence of a Frequency Error

The above description applies in the case of an ideal frequency source in the device. In reality, the device frequency reference is corrupted with a frequency error Δfₑᵣᵣ which impacts the transmitted waveforms:

s₁(t, t′, k)=e^{j2π(kΔF(t-T}^{_{CP}}^{)+Δf}^{ₑᵣᵣ}^{t′)} Eq. (8)

where t′ is defined across the full NPRACH transmission, and not only across a single symbol group as t, hence: 0≤t′≤N×4×T us with N defining the number of repetitions.

Also, the received wave form will be impacted by the frequency drift:

r₁(t, t′, k)=e^{j2πk(ΔF(t-D)+Δf}^{ₑᵣᵣ}^{(t+T}^{_{CP}}^{-D))} Eq. (9)

where t′ is limited to: 0≤t′≤N×4×T−T_{CP} us.

This frequency error will have a negative impact on the time of arrival estimation as it will cause a phase drift across the NPRACH symbol groups. For simplicity, again assume n=0, k=1 and t=0. t′ equals 0 at the beginning of the first symbol group and T at the beginning of the second symbol group. The correlation introduced above then gives:

$$\begin{matrix}{r}_{0} ( 0 , 0 , 1 ) \cdot {r}_{1}^{*} ( 0 , T , 2 ) = {e}^{j 2 π ( - Δ FD + Δ {f}_{err} ( {T}_{CP} - D ) )} \cdot \\ {e}^{- j 2 π ( - 2 Δ FD + Δ {f}_{err} ( T + {T}_{CP} - D ) )} \\ = {e}^{j 2 π ( Δ FD - Δ {f}_{err} T )}\end{matrix} \qquad Eq . ( 10 )$$

The argument, or angle, of the complex correlation metric, used to determine the delay D then becomes:

$$\begin{matrix}\begin{matrix}arg ( {r}_{0} ( 0 , 0 , 1 ) \cdot {r}_{1}^{*} ( 0 , T , 2 ) ) = {φ}_{01} \\ = 2 π ( Δ FD - Δ {f}_{err} T )\end{matrix} & Eq . ( 11 ) \\ D = \frac{{φ}_{01} + 2 πΔ {f}_{err} T}{2 πΔ F} = \frac{{φ}_{01}}{2 πΔ F} + \frac{Δ {f}_{err}}{Δ F} T & Eq . ( 12 )\end{matrix}$$

So in reality the delay estimation across symbol groups 0 and 1 will be biased by the magnitude of the frequency error.

If similarly estimating the delay over symbol groups 2 and 3 the result becomes:

$$\begin{matrix}\begin{matrix}{r}_{2} ( 0 , 2 T , 7 ) \cdot {r}_{3}^{*} ( 0 , 3 T , 6 ) = {e}^{j 2 π ( - 7 Δ FD + Δ {f}_{err} ( 2 T + {T}_{CP} - D ) )} \cdot \\ {e}^{- j 2 π ( - 6 Δ FD + Δ {f}_{err} ( 3 T + {T}_{CP} - D ) )} \\ = {e}^{j 2 π ( - Δ FD - Δ {f}_{err} T )}\end{matrix} & Eq . ( 11 ) \\ D = \frac{{φ}_{01} + 2 πΔ {f}_{err} T}{2 πΔ F} = \frac{{φ}_{01}}{2 πΔ F} + \frac{Δ {f}_{err}}{Δ F} T & Eq . ( 12 )\end{matrix}$$

In a final step, by combining ø₀₁ and ø₂₃ the frequency error is cancelled and an unbiased delay estimate can be obtained:

$$\begin{matrix}\begin{matrix}{φ}_{01} - {φ}_{23} = 2 π ( Δ FD - Δ {f}_{err} T ) - 2 π ( - Δ FD - Δ {f}_{err} T ) \\ = 4 πΔ FD\end{matrix} & Eq . ( 15 ) \\ D = \frac{{φ}_{01} - {φ}_{23}}{4 πΔ F} & Eq . ( 16 )\end{matrix}$$

Enhanced FDD NPRACH Time of Arrival Estimation in Presence of a Frequency Error

The symmetric hopping between symbol groups 0 and 1 and 2 and 3 supports, as described above, the cancellation of a frequency error when calculating the coarse round-trip time estimate. The same frequency cancellation is however not guaranteed when making the fine estimate using the large frequency hop. In the case of a single NPRACH transmission there is only one large frequency hop between symbol groups 1 and 2. The single time delay estimate obtainable is biased by the frequency error:

$$\begin{matrix}\begin{matrix}arg ( {r}_{1} ( 0 , T , 1 ) \cdot {r}_{2}^{*} ( 0 , 2 T , 7 ) ) = {φ}_{12} \\ = 2 π ( 6 Δ FD - Δ {f}_{err} - T )\end{matrix} & Eq . ( 17 ) \\ D = \frac{{φ}_{12} + 2 πΔ {f}_{err} T}{2 π6Δ} = \frac{{φ}_{12}}{2 π6Δ F} + \frac{Δ {f}_{err}}{6 Δ F} T & Eq . ( 18 )\end{matrix}$$

By configuring a repetition (see FIG. 5) a second large frequency hop takes place between symbol groups 5 and 6. Since also this frequency hop may increase the subcarrier frequency, then ø₅₆ may become identical to ø₁₂, and the simple combining scheme for cancelling the frequency error is no longer supported:

In 3GPP Release 14 and 15 it has been proposed [6] in 3GPP to introduce a restriction that guarantees that the large frequency hop should be pairwise symmetric across NPRACH repetitions. If the hop in the first repetition is in the positive direction (+22.5 kHz), then the hop in the second repetition should be in the negative direction (−22.5 kHz).

ϕ₅₆=2π(6ΔFD−ΔfₑᵣᵣT)=ϕ₁₂ Eq. (19)

Release 15 NB-IoT TDD NPRACH

One of the objectives for NB-IoT is to support TDD operation for in-band, guard-band, and standalone operation modes of NB-IoT. Indeed, the expedited standardization process in Rel-13 developed the air interface to support half-duplex FDD. However, TDD spectrum also exists globally, including regulatory environments and operator markets where there is strong un-met demand for NB-IoT. Therefore, Rel-15 is the right time to add TDD support into NB-IoT, after establishing what the needed targets in terms of coverage, latency, etc. should be.

The design for TDD shall assume no UL compensation gaps are needed by UE, and strive towards a common design among the deployment modes. Relaxations of MCL and/or latency and/or capacity targets to be considered. Baseline is to support the same features as Rel-13 NB-IoT, additionally considering small-cells scenarios.

As a background, the fundamental difference between FDD and TDD is that in a time division duplex operation the same carrier frequency is used for downlink and uplink transmissions.

In a TDD operation, the downlink and uplink radio resources have been made to coexist within the same radio frame, being the switching between downlink and uplink performed during a guard period contained within a special subframe. Table 1 shows the existing LTE TDD configurations as described by the LTE standard.

TABLE 1
Uplink-downlink TDD configurations

| | Downlink- | | | | | | | | | | | | | |
|---|---|---|---|---|---|---|---|---|---|---|---|---|---|---|
| | to-Uplink | | | | | | | | | | | Number of | | |
| Uplink- | Switch- | | | | | | | | | | | subframes/ | | |
| downlink | point | Subframe number | | | | | | | | | | frame | | |
| configuration | periodicity | 0 | 1 | 2 | 3 | 4 | 5 | 6 | 7 | 8 | 9 | DL | UL | S |
| 0 | 5 ms | D | S | U | U | U | D | S | U | U | U | 2 | 6 | 2 |
| 1 | 5 ms | D | S | U | U | D | D | S | U | U | D | 4 | 4 | 2 |
| 2 | 5 ms | D | S | U | D | D | D | S | U | D | D | 6 | 2 | 2 |
| 3 | 10 ms | D | S | U | U | U | D | D | D | D | D | 6 | 3 | 1 |
| 4 | 10 ms | D | S | U | U | D | D | D | D | D | D | 7 | 2 | 1 |
| 5 | 10 ms | D | S | U | D | D | D | D | D | D | D | 8 | 1 | 1 |
| 6 | 5 ms | D | S | U | U | U | D | S | U | U | D | 3 | 5 | 2 |

D: Downlink; U: Uplink; S: Special Subframe

The LTE TDD configurations #1, #2, #3, #4, and #5 will be supported for TDD NB-IoT (i.e., The TDD configuration #0 won't be supported, while the TDD configuration #6 might be).

Regarding NPRACH for TDD NB-IoT, there is a set of design guidelines as follows. TDD NPRACH supports at least 3.75 kHz subcarrier spacing single-tone with frequency hopping. 5 kHz subcarrier spacing may be supported e.g. for UL-DL configuration #2.

NPRACH formats using G symbol groups with back-to-back transmission followed by a guard time are supported for 1, 2, and 3 contiguous uplink subframes, An NPRACH format is associated with one value of N (the number of symbols per symbol group) and CP duration.

P is the number of symbol groups in a preamble and is even. For the G symbols groups that are transmitted back-to-back with 3.75 kHz subcarrier spacing, 3.75 kHz and 22.5 kHz hopping distances are supported.

Hopping between discontinuous transmissions within one preamble may be supported.

Cell specific pseudo-random hopping is used between NPRACH preamble repetitions

Frequency hopping for NPRACH in TDD NB-IoT, due to decisions on some other design criterions (e.g., the number of symbol groups composing one NPRACH preamble repetition unit) mat be different as compared to the frequency hopping design used for the Rel-13 NPRACH in FDD NB-IoT. Moreover, some enhancements on the “frequency hopping” with respect to NPRACH in FDD NB-IoT might be considered, which might be equally impacted by other design criterions.

In FDD NB-IoT, a bandwidth of 45 kHz is used to support up to 12 orthogonal symbol groups being transmitted simultaneously, which are part of different NPRACH preamble repetition units. Moreover, the hopping pattern makes use of 3.75 kHz (1 tone hopping) and 22.5 kHz (6 tone hopping) hopping distances. Tables 2-4 show the four-possible deterministic frequency hopping patterns for NPRACH preamble repetition units in FDD NB-IoT, which are compared against the frequency hopping patterns that might be used for the NPRACH preamble repetition units in TDD NB-IoT when the symbol groups composing one preamble repetition unit is kept as 4 (i.e. P=4).

TABLE 2
Deterministic hopping patterns for NPRACH in FDD

| Index of the tone used by | Deterministic hopping patterns within |
|---|---|
| the first symbol group | a repetition unit |
| 0, 2, 4 | {+1, +6, −1} |
| 1, 3, 5 | {−1, +6, +1} |
| 6, 8, 10 | {+1, −6, −1} |
| 7, 9, 11 | {−1, −6, +1} |

TABLE 3
Deterministic hopping patterns for NPRACH in TDD
with no hopping after discontinuity (if any)

| Index of the tone used | Deterministic hopping patterns |
|---|---|
| by the first symbol group | within a repetition unit |
| 0, 2, 4 | {+1, 0, +6} |
| 1, 3, 5 | {−1, 0, +6} |
| 6, 8, 10 | {+1, 0, −6} |
| 7, 9, 11 | {−1, 0, −6} |

As shown in Table 3, one possibility is not performing a hopping after the discontinuity. However, some embodiments have a configurable hopping after the discontinuity as shown in Table 1c.

TABLE 4
Deterministic hopping patterns for NPRACH in TDD
with a configurable hopping after the discontinuity (if any)

| Index of the tone used | Deterministic hopping patterns |
|---|---|
| by the first symbol group | within a repetition unit |
| 0, 2, 4 | {+1, X, +6} |
| 1, 3, 5 | {−1, X, +6} |
| 6, 8, 10 | {+1, X, −6} |
| 7, 9, 11 | {−1, X, −6} |

In Table 4, the value of X is configurable. In some embodiments, X is chosen among the values in the following set: X=+/−{0, 1, 2, 3, 4, 5}.

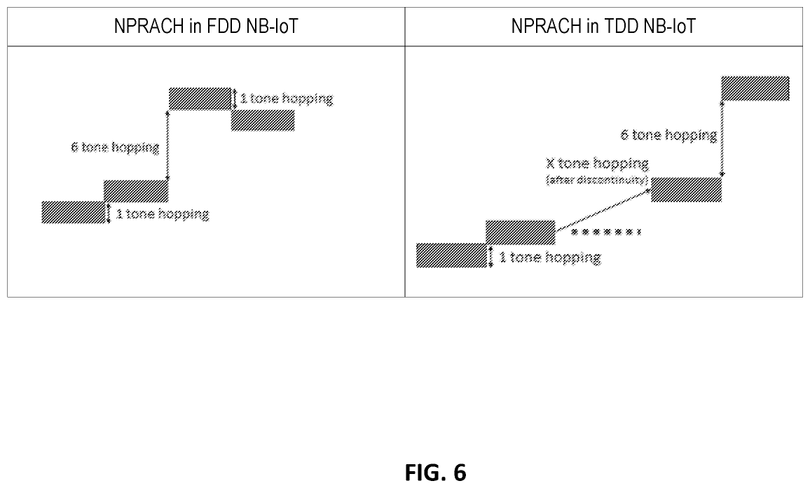

FIG. 6 shows an NPRACH preamble repetition unit as it is in FDD NB-IoT, and how it can be kept similar for TDD NB-IoT when P=4. The details on frequency hopping for TDD NB-IoT depicted in FIG. 6, simply refer to one example of the tone relation between the four symbol groups from Table 4.

Some solutions for cancelling the phase error produced by the frequency offset propose a conditional hopping for the next preamble repetition unit that depends on the Index of the tone used by the first symbol group in the previously transmitted preamble repetition unit. In other words:
if a preamble repetition unit has been transmitted using index 0, 2, or 4 (or 1, 3, 5) for its first symbol group, then the candidate indexes for the first symbol group in the next preamble repetition unit are 6, 8, 10, 7, 9, or 11.
On the other hand, if a preamble repetition unit has been transmitted using index 6, 8, or 10 (or 7, 9, 11) for its first symbol group, then the candidate indexes for the first symbol group in the next preamble repetition unit are 0, 2, 4, 1, 3, or 5.

So, aiming at cancelling phase errors, for a preamble repetition unit that has been transmitted with a given tone index for its first symbol group, the candidate tone index for the first symbol group in the next preamble repetition unit will be confined to one of the tone indexes in the opposite half of the bandwidth. This is illustrated in Tables 5a-5b.

TABLE 5a
Conditional frequency hopping for the next preamble repetition
unit to start on the upper half of the NPRACH bandwidth.
Previous repetition Next repetition

| | Candidate Indexes for the |
|---|---|
| Index of the tone used | tone to be used by the first |
| by the first symbol group | symbol group in the next preamble |
| 0, 2, 4 | 6, 8, 10 |
| | 7, 9, 11 |
| 1, 3, 5 | 6, 8, 10 |
| | 7, 9, 11 |

TABLE 5b
Conditional frequency hopping for the next preamble repetition
unit to start on the lower half of the NPRACH bandwidth.
Previous repetition Next repetition

| | Candidate Indexes for the |
|---|---|
| Index of the tone used | tone to be used by the first |
| by the first symbol group | symbol group in the next preamble |
| 6, 8, 10 | 0, 2, 4 |
| | 1, 3, 5 |
| 7, 9, 11 | 0, 2, 4 |
| | 1, 3, 5 |

Some embodiments deal with the “frequency hopping” design for NPRACH in TDD NB-IoT, considering the set of agreements reached in 3GPP, and the potential incorporation of enhancements embedded into the “frequency hopping”.

There currently exist certain challenge(s). Methods for cancelling out a frequency error Δfₑᵣᵣ imposed on the NPRACH wave form have been described. In reality the frequency error introduce by a mobile device is however not constant. It is typically drifting in time and can in case of a linear drift be defined as:

Δfₑᵣᵣ=Δf₀+df·t Eq. (20)

where Δf₀ is a fixed frequency error, and df is the rate by which the frequency is drifting. Δf₀ is typically due to an inaccurate synchronization to the downlink synchronization signals. df is typically due to the heating of the crystal oscillator generating the reference frequency in the mobile device.

With a drifting frequency error the methods presented above are compromised. As long as the time between the pairwise frequency hops +3.75 kHz, −3.75 kHz, and +22.5 kHz, −22.5 kHz is short the impact from df is limited, and the solutions can be said to cancel out the frequency error.

But for NB-IoT TDD, the P symbol groups defining the full NPRACH transmission may be spread across multiple sets of G symbol groups that are mapped to available UL subframes. Between the transmission of the G back-to-back symbol groups, DL and special subframes will create time gaps that makes the herein discussed frequency cancellation methods prone to non-constant frequency errors drifting over time.

Some embodiments thereby provide a method for the “frequency hopping” design for NPRACH in TDD NB-IoT, considering the design guidelines of the agreements reached in 3GPP while making the design resistant towards frequency errors.

In some embodiments, for example, the frequency hopping patterns for NPRACH in TDD NB-IoT are formed from configurable and/or predefined tone indexes (including 3.75 kHz and 22.5 kHz hopping distances) selected to partially or fully cancel out phase errors within one single NPRACH preamble repetition unit (also referred to simply as one single NPRACH preamble). In one embodiment, for example, the frequency hopping patterns are configured to pairwise hop upwards (+3.75 or +22.5 kHz) and downwards (−3.75 or −22.5 kHz). By ensuring that phase error cancellation can be performed within a single NPRACH preamble repetition unit, the NPRACH transmission may be confined in time to the maximum extent possible which makes the transmission less prone to frequency errors.

In some embodiments, the frequency hopping patterns for NPRACH in TDD NB-IoT have a hopping distance for every symbol group composing one NPRACH preamble repetition unit, where the hopping distances associated to the symbol groups can be equal or different, predetermined and/or configurable.

According to some embodiments, for the support of NPRACH for TDD NB-IoT, a frequency hopping design is presented where the hopping distances associated to the symbol groups composing an NPRACH preamble repetition unit can be equal or different, predetermined and/or configurable. The configurable and/or predefined tone indexes (including 3.75 kHz and 22.5 kHz hopping distances) can be selected to cancel out phase errors within a sole NPRACH preamble repetition unit. That is, the symbol groups can be made to hop upwards and downwards nullifying each other for canceling phase errors within an NPRACH preamble repetition unit.

Certain embodiments may provide one or more of the following technical advantage(s). A frequency hopping design for NPRACH in TDD NB-IoT with configurable and/or predefined hopping distances (including 3.75 kHz and 22.5 kHz) can be used to cancel out frequency and phase errors at the eNB when processing the received NPRACH signal within one NPRACH preamble repetition unit (i.e., the phase errors caused by a frequency error nullify each other when hopping upwards and downwards within one NPRACH preamble repetition unit) rather than having to wait for the next NPRACH preamble repetition unit transmission to cancel out the phase errors. Alternatively or additionally, cancelling phase errors within an NPRACH preamble repetition unit avoids the need of having to introduce a conditional hopping, which involves the transmission of at least two preamble repetition units to obtain the frequency and phase error cancelation. Alternatively or additionally, the ability of cancelling frequency and phase errors within an NPRACH preamble repetition unit makes the performance robust towards drifting frequency errors, especially in TDD configurations where there is only one uplink subframe available per radio frame (e.g., TDD configuration #5), in which case (i.e., depending on the NPRACH preamble format) the frequency and phase error cancelation could take up to two radio frames, while if the frequency and phase error cancelation depends on the transmission of two adjacent NPRACH preamble repetition units then the phase error cancellation could take up four radio frames. Alternatively or additionally, the ability of cancelling frequency and phase errors within an NPRACH preamble repetition unit might result in reducing the number of required repetitions, since the frequency and phase error cancelation is achieved earlier.

More particularly, if the NPRACH preamble repetition unit consists of four symbol groups (i.e., P=4=G+G), then it would be possible re-use the deterministic hopping patterns as designed for FDD NB-IoT or use the variants displayed in Table 1c, which doesn't preclude incorporating the solution for cancelling the phase errors illustrated in Tables 3a and 3b.

On the other hand, if G=3, then the value of P may be 6 (i.e., G+G). This results to be different as compared to the number of symbol groups composing one NPRACH preamble repetition unit in FDD NB-IoT. Hence, the deterministic hopping patterns for TDD NB-IoT would have to be re-designed.

In some embodiments, for example, the hopping patterns for TDD NB-IoT may be designed as shown in Table 4.

TABLE 6
NPRACH in TDD with configurable hopping distances
when G = 3 and P = 6 = G + G

| Index of the tone | Deterministic hopping patterns |
|---|---|
| used by the first symbol | within a NPRACH preamble repetition |
| group | unit |
| 0, 2, 4 | {+1, +6, 0, −6, −1} |
| 1, 3, 5 | {−1, +6, 0, −6, 1} |
| 6, 8, 10 | {+1, −6, 0, 6, −1} |
| 7, 9, 11 | {−1, −6, 0, 6, 1} |

Configuring and/or predetermining appropriate hopping patterns as in the example shown in Table 6, makes it possible in some embodiments to cancel out phase errors within an NPRACH preamble repetition unit.

Table 7 shows an example of 12 orthogonal symbol groups composing different NPRACH preamble repetition units, which are being transmitted simultaneously, hopping over the 45 KHz bandwidth making use of the frequency hopping patterns described in Table 6.

TABLE 7
Deterministic hopping patterns for NPRACH in TDD, when an
NPRACH preamble repetition unit is composed by six symbol
groups (P = 6), and where the phase cancellation is achieved
within an NPRACH preamble repetition unit.

| SG0 | SG1 | SG2 | SG3 | SG4 | SG5 | Residual hop |
|---|---|---|---|---|---|---|
| 0 | 1 | 7 | 7 | 1 | 0 | 0 |
| | | | | | | SG5 = SG1 |
| 1 | 0 | 6 | 6 | 0 | 1 | 0 |
| | | | | | | SG5 = SG1 |
| 2 | 3 | 9 | 9 | 3 | 2 | 0 |
| | | | | | | SG5 = SG1 |
| 3 | 2 | 8 | 8 | 2 | 3 | 0 |
| | | | | | | SG5 = SG1 |
| 4 | 5 | 11 | 11 | 5 | 4 | 0 |
| | | | | | | SG5 = SG1 |
| 5 | 4 | 10 | 10 | 4 | 5 | 0 |
| | | | | | | SG5 = SG1 |
| 6 | 7 | 1 | 1 | 7 | 6 | 0 |
| | | | | | | SG5 = SG1 |
| 7 | 6 | 0 | 0 | 6 | 7 | 0 |
| | | | | | | SG5 = SG1 |
| 8 | 9 | 3 | 3 | 9 | 8 | 0 |
| | | | | | | SG5 = SG1 |
| 9 | 8 | 2 | 2 | 8 | 9 | 0 |
| | | | | | | SG5 = SG1 |
| 10 | 11 | 5 | 5 | 11 | 10 | 0 |
| | | | | | | SG5 = SG1 |
| 11 | 10 | 4 | 4 | 10 | 11 | 0 |
| | | | | | | SG5 = SG1 |

Focusing on the second row of the above table, observe that the first symbol group (i.e., SG0) starts at the lower end of 45 kHz bandwidth, the second symbol group (i.e., SG1) moves one tone up (i.e., 3.75 kHz above the previous symbol group), the third symbol group (i.e., SG2) yet again moves up to the seventh tone index (i.e., 6 tones up with respect to the previous symbol group), the fourth symbol group (i.e., SG3) remains in the seventh tone (i.e., no hop with respect to the previous symbol group), the fifth symbol group (i.e., SG4) moves down to the tone index number one (i.e., six tones down with respect to the previous index), and finally the last symbol group composing the NPRACH preamble repetition unit moves one tone down with respect to the previous symbol group. The last column shows that the residual hopping is zero, since the last symbol group within the preamble repetition unit has returned to the same tone index used by the first symbol group of the preamble repetition unit.

Moreover, in some embodiments, the hoping distance after the discontinuity* is made configurable given by the variable X, while the rest is hardcoded aiming at performing the hop cancelation within one preamble repetition unit (i.e., within P) as shown in Table 5.

*Note: Recall that there are discontinuities in the UL transmissions due to DL subframes appearing in middle depending on the TDD configuration.

TABLE 8

| NPRACH in TDD with one (i.e., X) configurable hopping distance | |
|---|---|
| when G = 3 and P = 6 = G + G | |
| Index of the tone | Deterministic hopping patterns |
| used by the first | within a NPRACH preamble |
| symbol group | repetition unit |
| 0, 2, 4 | {+1, +6, X, −6, −1} |
| 1, 3, 5 | {−1, +6, X, −6, 1} |
| 6, 8, 10 | {+1, −6, X, 6, −1} |
| 7, 9, 11 | {−1, −6, X, 6, 1} |

The variable X in some embodiments is configured (but not limited) from one of the values in the following set used as example: +/−{0, 1, 2, 3, 4, 5, 6}. If in the above example, X=0, then the result will be the same as the one depicted in Table 7.

On the hand, more than one hopping distance associated to the symbol groups composing one preamble may be made configurable as shown in Table 9.

TABLE 9

| NPRACH in TDD with more than one (i.e., Xl, X2, X3, and X4) | |
|---|---|
| configurable hopping distance when G = 3 and P = 6 = G + G | |
| Index of the tone | Deterministic hopping patterns |
| used by the first | within a NPRACH preamble |
| symbol group | repetition unit |
| 0, 2, 4 | {+1, +6, −1, X1, X3} |
| 1, 3, 5 | {−1, +6, +1, X1, X4} |
| 6, 8, 10 | {+1, −6, −1, X2, X3} |
| 7, 9, 11 | {−1, −6, +1, X2, X4} |

In Table 9, the values for the variables X1, X2, X3 and X4 are configurable from one of the values in the following set used as example: +/−{0, 1, 2, 3, 4, 5, 6}. The values in the set from where the configurable hopping distance is retrieved can be any positive or negative integer number, while the configurable variables can be used all along the number of tones encompassing the NPRACH bandwidth. If some symbol groups are associated to predefined tone distances, then the number of configurable variables are less than P (i.e., Xi where i<P).

Combining the configurability of hopping distances with using predefined values for some other hopping distances within one preamble repetition unit can be used to achieve good trade-offs between implementations that are fully flexible, and some others that are not. For example, the hopping distances can be the same as in the legacy starting over cyclically if there were implementation related restrictions, while more flexible implementations can assign values to the configurable variables aiming at achieving a quasi or full hopping cancellation within P.

Alternating the hopping distances upwards and downwards nullifying each other is what allows for cancelling the phase and frequency errors. This can be achieved within an NPRACH preamble repetition unit, rather than having to wait for the next NPRACH preamble repetition unit transmission to cancel out the phase errors.

The ability of cancelling phase errors within an NPRACH preamble avoids the need of having to introduce a conditional hopping, improves the ability to cancel phase and frequency errors, and may help to reduce the number of required repetitions.

Accordingly, in one embodiment, the frequency hopping patterns for NPRACH in TDD NB-IoT have a hopping distance for every symbol group composing an NPRACH preamble repetition unit, where the hopping distances associated to the symbol groups composing one NPRACH preamble repetition unit are equal or different, predetermined and/or configurable.

In one embodiment, the configurable variable(s) determining the hopping distance for the symbol groups composing one NPRACH preamble repetition unit (i.e., the frequency hopping pattern) are obtained from a set of values consisting of positive and/or negative integer numbers (e.g., +/−{0, 1, 2, 3, 4, 5, 6}). In relation with the above embodiment, configurable hopping distances may be used all along the number of tones encompassing the NPRACH bandwidth (e.g., twelve tones of 3.75 kHz each spanning over 45 kHz).

In one embodiment, a configurable variable may determine the hopping distance for at least one of the symbol groups composing one NPRACH preamble repetition unit (i.e., the frequency hopping pattern). That is, configurable hopping distances on certain symbol groups may be combined with predetermined hopping distances set on the rest of symbol groups composing one NPRACH preamble repetition unit.

In one embodiment, frequency hopping patterns for NPRACH in TDD NB-IoT with configurable and/or predefined tone indexes (including 3.75 kHz and 22.5 kHz hopping distances) are selected to at least partially cancel out phase and frequency errors within an NPRACH preamble repetition unit. That is, the symbol groups may be made to hop upwards and downwards at least partially nullifying each other for canceling phase errors within a sole NPRACH preamble repetition unit.

In one embodiment, cancelling phase errors within an NPRACH preamble repetition unit avoids the need of having to introduce a conditional hopping on subsequent NPRACH preamble repetition units, reduces the amount of time required for performing the phase error cancellation, and may help to decrease the number of required NPRACH repetitions.

In one embodiment, several predefined hopping patterns are specified (e.g., predefined), and the network indicates which hopping pattern the UE should use in the system information or other configuration information.

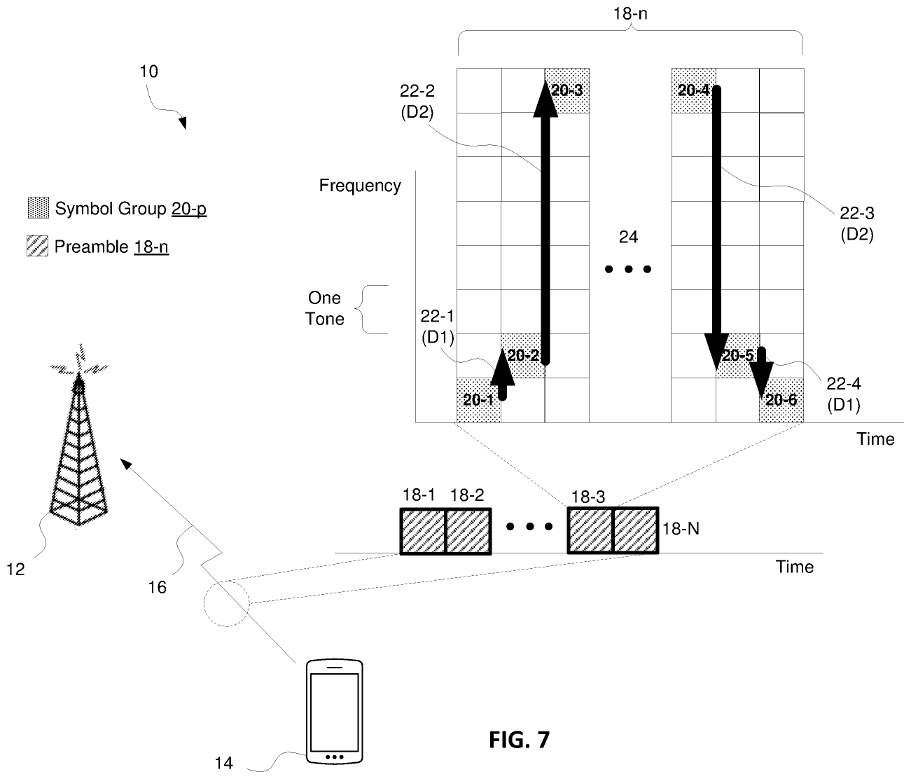

FIG. 7 illustrates an exemplary embodiment where the transmission of a random access preamble 18 one or more times. FIG. 7 in this regard shows the transmission 16 comprises transmission of the random access preamble 18 N times, with transmission of the preamble 18 each time shown as preamble 18-n, i.e., the preamble 18 is transmitted N times as preamble 18 1 . . . 18 N, N≥1. In some embodiments, this means that one or more repetitions of the preamble 18 are transmitted (where even the first transmission may be referred to as a repetition). In some embodiments, then, the preamble 18 may therefore appropriately be referred to as a preamble repetition unit, e.g., based on the transmission 16 comprising one or more repetitions of the preamble 18 as a unit. The number N of times the preamble 18 is transmitted may accordingly also be referred to as the number N_{REP} of repetitions of the preamble 18.

In any event, the preamble 18 comprises multiple symbol groups 20 as shown in FIG. 7. Each symbol group 20 comprises one or more symbols (e.g., a cyclic prefix and a sequence of multiple symbols, such as five symbols that may be identical). For example, in some embodiments, a random access preamble 18 consists of P symbol groups. In some embodiments P may be greater than or equal to 6. FIG. 7 shows an example where the preamble 18 comprises P=6 symbol groups, illustrated as symbol groups 20-1, 20-2, 20-3, 20-4, 20-5, and 20-6.

The wireless device 14 notably uses frequency hopping to transmit the preamble 18 one or more times. In some embodiments, for example, each symbol group 20 may be transmitted on a single respective subcarrier or tone. That is, each symbol group 20 spans only a single tone in frequency. With frequency hopping, though, the groups 20 are not all transmitted on the same tone. Instead, at least some of the symbol groups 20 are transmitted at different frequency locations so as to be transmitted on different subcarriers or tones. In some embodiments, the random access channel transmission 16 is frequency hopped on a symbol group by symbol group basis (i.e., from symbol group to symbol group), e.g., according to a frequency hopping pattern.

FIG. 7 shows frequency hopping used to transmit the random access preamble 18 one of the one or more times, i.e., namely, the frequency hopping used to transmit random access preamble 18-n . This frequency hopping may therefore be the frequency hopping used for transmitting a single or sole preamble repetition unit. Although shown with respect to transmission of the preamble 18 a single one of the one or more times, in some embodiments, the same frequency hopping (pattern) may be used to transmit the preamble 18 each of the one or more times.

As shown, the frequency hopping used to transmit the random access preamble 18-n includes an upward hop 22-1 by a first frequency distance D1. More particularly, the random access preamble 18-n is hopped upward in frequency from a first symbol group 20-1 to a second symbol group 20-2 over the first frequency distance D1. As shown, for example, this first frequency distance D1 is a distance between (the centers of) adjacent subcarriers, e.g., such that the upward hop 22-1 is over a frequency distance of one tone or subcarrier (e.g., 3.75 kHz).

The frequency hopping used to transmit the random access preamble 18-n also includes an upward hop 22-2 by a second frequency distance D2. More particularly, the random access preamble 18-n is hopped upward in frequency from the second symbol group 20-2 to a third symbol group 20-3 over a second frequency distance D2. As shown, for example, this second frequency distance D2 is a distance between (the centers of) every sixth subcarrier, e.g., such that the upward hop 22-2 is over a frequency distance of six tones or subcarriers (e.g., 22.5 kHz).

In some embodiments, the preamble 18-n is transmitted discontinuously in time such that the preamble 18-n includes a discontinuity 24 in time. In one embodiment, for example, the discontinuity 24 is attributable to one or more subframes being usable during the discontinuity 24 only for downlink or otherwise being unusable for transmission in the uplink or for transmission of the preamble 18n. In another embodiments, the discontinuity 24 is attributable to a transmission gap being introduced in the uplink transmission 16, e.g., the transmission 16 is postponed until after the transmission gap.

FIG. 7 shows an example where a fourth symbol group 20-4 after the discontinuity 24 is transmitted on the same tone or subcarrier as the third symbol group 20-3 before the discontinuity 24, i.e., where the frequency distance over which the preamble 18-n is hopped from the third to the fourth symbol group is zero. However, in other embodiments not shown, the frequency hopping distance across the discontinuity is X, where X may be predefined or configurable to have a non-zero value.

Without any regard to whether and/or the extent to which frequency hopping is employed across the discontinuity, or even whether any such discontinuity 24 exists, additional frequency hopping is advantageously used for transmission of other symbol groups in the preamble 18-n to enable frequency errors at the wireless device 14 and/or radio network node 12 to be accounted for, e.g., when the radio network node 12 determines the time alignment or timing advance for the wireless device 14. In one embodiment, for example, the frequency hopping enables the radio network node 12 to cancel, nullify, or otherwise mitigate phase errors attributable to such frequency errors.

In these and other embodiments, then, the frequency hopping used to transmit the random access preamble 18-n additionally includes a downward hop 22-3 by the second frequency distance D2. More particularly, the random access preamble 18-n is hopped downward in frequency from the fourth symbol group 20-4 to a fifth symbol group 20-5 over the second frequency distance D2. Accordingly, then, the downward hop 22-3 by the second frequency distance D2 offsets the upward hop 22-2 by the second frequency distance D2, e.g., in the sense that hop 22-3 is opposite in direction from but equal in magnitude to hop 22-2. In some embodiments, hops 22-2 and 22-3 constitute a pair of hops that fully offset one another.

Moreover, the frequency hopping used to transmit the random access preamble 18-n also includes a downward hop 22-4 by the first frequency distance D1. More particularly, the random access preamble 18-n is hopped downward in frequency from the fifth symbol group 20-5 to a sixth symbol group 20-6 over the first frequency distance D1. Accordingly, then, the downward hop 22-4 by the first frequency distance D1 offsets the upward hop 22-1 by the first frequency distance D1, e.g., in the sense that hop 22-4 is opposite in direction from but equal in magnitude to hop 22-1. In some embodiments, hops 22-1 and 22-4 constitute a pair of hops that fully offset one another.

Consider an example where the frequency hopping across the preamble 18-n is represented as a pattern of frequency hops. Each hop may be defined in terms of an upward or downward hop direction and a magnitude. The magnitude may be defined as a number of subcarrier or tone indices constituting the hop. In this case, the frequency hopping in the example of FIG. 7 may be represented as {+1, +6, 0, −6, −1}. Alternatively, in other embodiments where the frequency hop across the discontinuity is X, the frequency hopping may be represented as {+1, +6, X, −6, −1}.

In these and other embodiments, other frequency hopping possible for other preamble repetitions and/or for other wireless devices may be selected from a set of: {+1, +6, 0, −6, −1}, {−1, +6, 0, −6, +1}, {+1, −6, 0, +6, −1}, and {1, −6, 0, +6, +1}. Alternatively, the set may include {+1, +6, X, −6, −1}, {−1, +6, X, −6, +1}, {+1, −6, X, +6, −1}, or {1, −6, X, +6, +1}. In some embodiments, X is configurable as 0, +/−1, +/−2, +/−3, +/−4, +/−5, or +/−6.

Regardless of the particular frequency hopping, the radio network node 12 correspondingly receives the transmission 16 using frequency hopping. The radio network node 12 in some embodiments determines a timing advance based on the transmission 16, i.e., based on the random access preamble 18. The radio network node 12 may signal this timing advance to the wireless device 14.

More particularly, the radio network node 12 in some embodiments determines, based on the random access preamble 18-n as received one of the one or more times, multiple round-trip time estimates between the radio network node 12 and the wireless device 14. The multiple round-trip time estimates include a first estimate based on the upward hop 22-1 and the downward hop 22-4 and further include a second estimate based on the upward hop 22-2 and the downward hop 22-3. Each of the multiple round-trip time estimates may be an unbiased estimate that is unbiased by inter-group phase drift (attributable to frequency error at the wireless device and/or radio network node). In one embodiment, for instance, the radio network node 12 calculates the first estimate as

$${D}_{1} = \frac{{φ}_{U 1} - {φ}_{D 1}}{4 πΔ F}$$

and the second estimate as

$${D}_{2} = \frac{{φ}_{U 2} - {φ}_{D 2}}{4 πΔ F} ,$$

where ø_{U1} is an angle of a complex correlation metric between symbol groups associated with the upward hop 22-1, ϕ_{D1} is an angle of a complex correlation metric between symbol groups associated with the downward hop 22-4, ϕ_{U2} is an angle of a complex correlation metric between symbol groups associated with the upward hop 22-2, ϕ_{D2} is an of a complex correlation metric between symbol groups associated with the downward hop 22-3, and ΔF is a subcarrier spacing between subcarriers on which the random access preamble is received.

In these and other embodiments, then, multiple round-trip estimates (also referred to as delay estimates) may be obtained from reception of the preamble 18 a single time, i.e., from a single preamble repetition unit. For example, both a coarse-grained round-trip estimate and a fine-grained round-trip estimate may be obtained.

Note that although the above embodiments have been described for realizing full phase error cancelation, other embodiments may realize at least partial (i.e., quasi) phase error cancelation. Such partial or quasi phase error calculation may be realized for instance by a pair of frequency hops that partially offset one another to at least a certain extent, e.g., by less than or equal to 1 or 2 tones.

Note that in the example of FIG. 7, the frequency distance between the frequency on which the first symbol group 20-1 is transmitted and the frequency on which the last symbol group 20-6 of the preamble 18 is transmitted is equal to zero. That is, the frequency distance between a frequency on which transmission of the random access preamble 18-n starts and a frequency on which transmission of the random access preamble 18-n ends is zero.

In some embodiments, the frequency hopping includes a hop by a pseudo random frequency distance between transmissions of the random access preamble 18. In FIG. 7, for instance, a (cell-specific) pseudo-random frequency hop occurs between random access preambles 18-n and 18-(n+1).

A tone as used herein may correspond to a subcarrier in some embodiments. A tone may for instance correspond to an OFDM subcarrier or an SC-FDMA subcarrier.

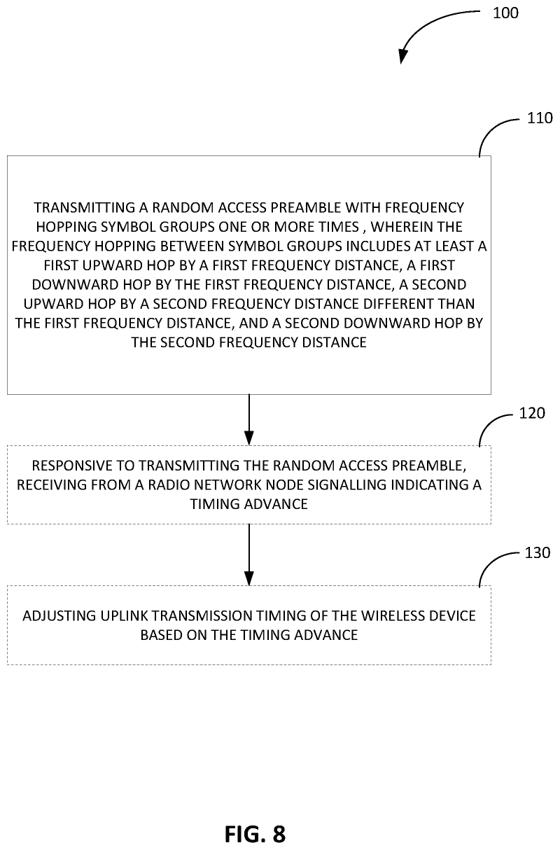

FIG. 8 depicts a method 100 performed by a wireless device 14 (e.g., a user equipment) in accordance with particular embodiments. The method 100 includes transmitting a random access preamble with frequency hopping symbol groups 20 one or more times (block 110). In some embodiments, frequency hopping between the symbol groups 20 includes at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise a cyclic prefix followed by one or more symbols.

In some embodiments, the method 100 further includes responsive to transmitting the random access preamble, receiving from a radio network node signaling indicating a timing advance (TA) (block 120). The method 100 may also include adjusting uplink transmission timing of the wireless device based on the timing advance (block 130).

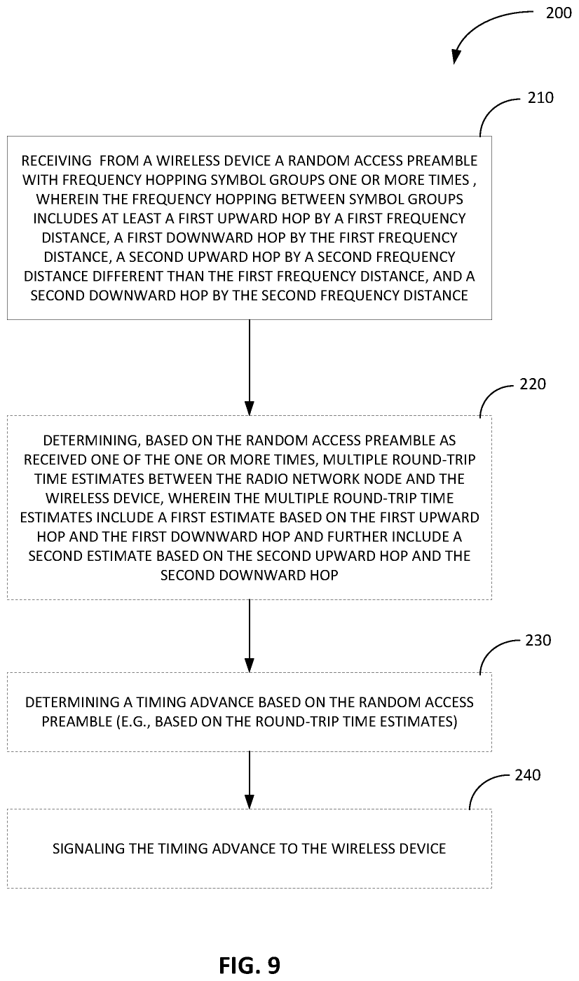

FIG. 9 depicts a method 200 performed by a radio network node 12 (e.g., a base station) in accordance with other particular embodiments. The method 200 includes receiving from a wireless device 14 a random access preamble with frequency hopping symbol groups 20 one or more times (block 210). The frequency hopping between the symbol groups 20 includes at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise a cyclic prefix followed by one or more symbols.

In some embodiments, the method 200 also comprises determining, based on the random access preamble as received one of the one or more times, multiple round-trip time estimates between the radio network node and the wireless device (block 220). In one embodiment, for example, the multiple round-trip time estimates include a first estimate based on the first upward hop and the first downward hop and further include a second estimate based on the second upward hop and the second downward hop.

Alternatively or additionally, the method 200 may comprise determining a timing advance based on the random access preamble (e.g., based on the multiple round-trip time estimates) (block 230). The method may also comprise signaling the timing advance to the wireless device (block 240).

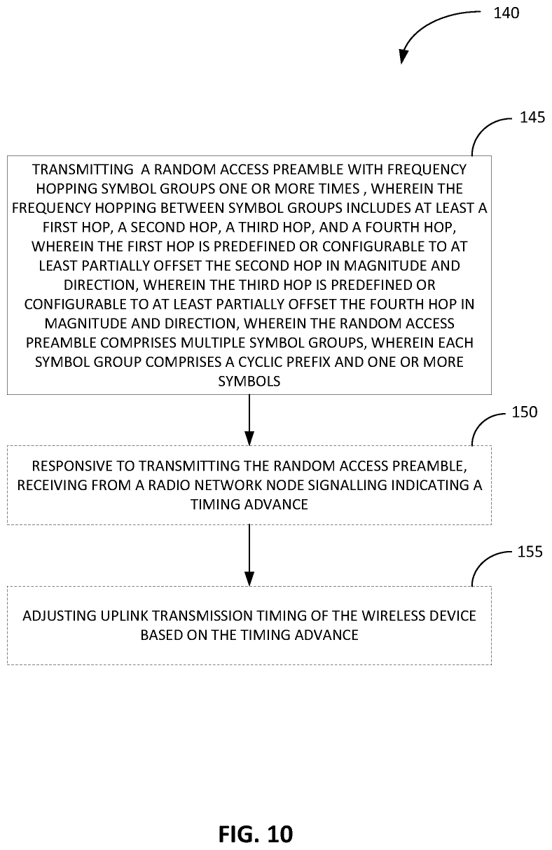

FIG. 10 depicts a method 140 performed by a wireless device 14 (e.g., a user equipment) in accordance with particular embodiments. The method 140 includes transmitting a random access preamble with frequency hopping symbol groups 20 one or more times (block 145). In some embodiments, frequency hopping between the symbol groups 20 includes at least a first hop, a second hop, a third hop, and a fourth hop. The first hop may be predefined or configurable to at least partially offset the second hop in magnitude and direction. The third hop may be predefined or configurable to at least partially offset the fourth hop in magnitude and direction. The random access preamble may comprise multiple symbol groups. Each symbol group may comprise a cyclic prefix followed by one or more symbols.

In some embodiments, the method 140 further includes responsive to transmitting the random access preamble, receiving from a radio network node signaling indicating a timing advance (TA) (block 150). The method 100 may also include adjusting uplink transmission timing of the wireless device based on the timing advance (block 155).

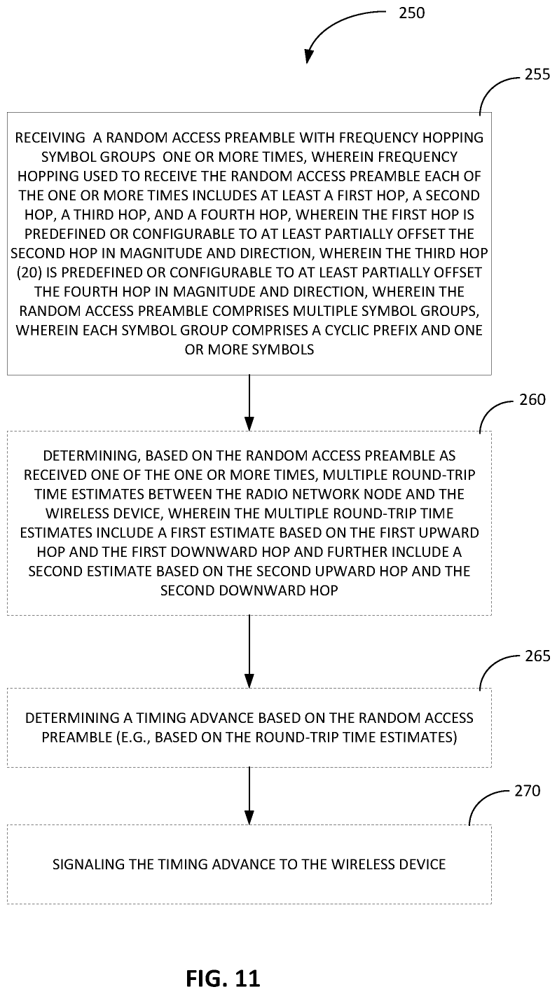

FIG. 11 depicts a method 250 performed by a radio network node 12 (e.g., a base station) in accordance with other particular embodiments. The method 250 includes receiving from a wireless device 14 a random access preamble with frequency hopping symbol groups 20 one or more times (block 255). The frequency hopping between the symbol groups 20 includes at least a first hop, a second hop, a third hop, and a fourth hop. The first hop is predefined or configurable to at least partially offset the second hop in magnitude and direction. The third hop may be predefined or configurable to at least partially offset the fourth hop in magnitude and direction, wherein the random access preamble comprises multiple symbol groups, wherein each symbol group comprises one or more symbols. The random access preamble may comprise multiple symbol groups. Each symbol group may comprise a cyclic prefix followed by one or more symbols.

In some embodiments, the method 250 also comprises determining, based on the random access preamble as received one of the one or more times, multiple round-trip time estimates between the radio network node and the wireless device (block 260). In one embodiment, for example, the multiple round-trip time estimates include a first estimate based on the first upward hop and the first downward hop and further include a second estimate based on the second upward hop and the second downward hop.

Alternatively or additionally, the method 250 may comprise determining a timing advance based on the random access preamble (e.g., based on the multiple round-trip time estimates) (block 265). The method 250 may also comprise signaling the timing advance to the wireless device (block 270).

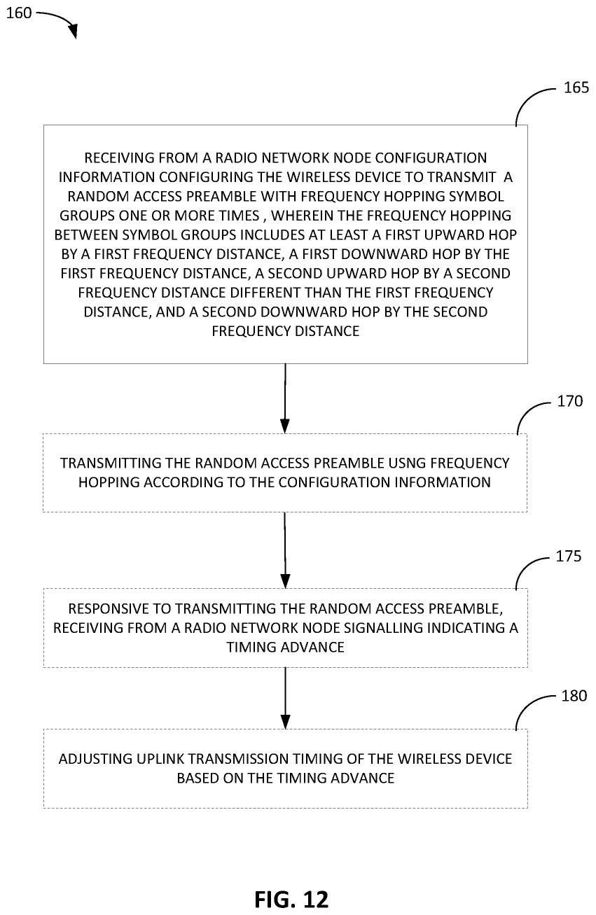

FIG. 12 depicts a method 160 performed by a wireless device 14 (e.g., a user equipment) in accordance with particular embodiments. The method 160 includes receiving from a radio network node 12 configuration information that configures the wireless device 14 to transmit a random access preamble with frequency hopping symbol groups 20 one or more times (block 165). In some embodiments, frequency hopping between the symbol groups 20 includes at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise a cyclic prefix followed by one or more symbols.

In some embodiments, the method 165 further includes transmitting the random access preamble using frequency hopping according to the configuration received from the radio network node 12 (block 170). Responsive to transmitting the random access preamble, receiving from a radio network node signaling indicating a timing advance (TA) (block 175). The method 100 may also include adjusting uplink transmission timing of the wireless device based on the timing advance (block 180).

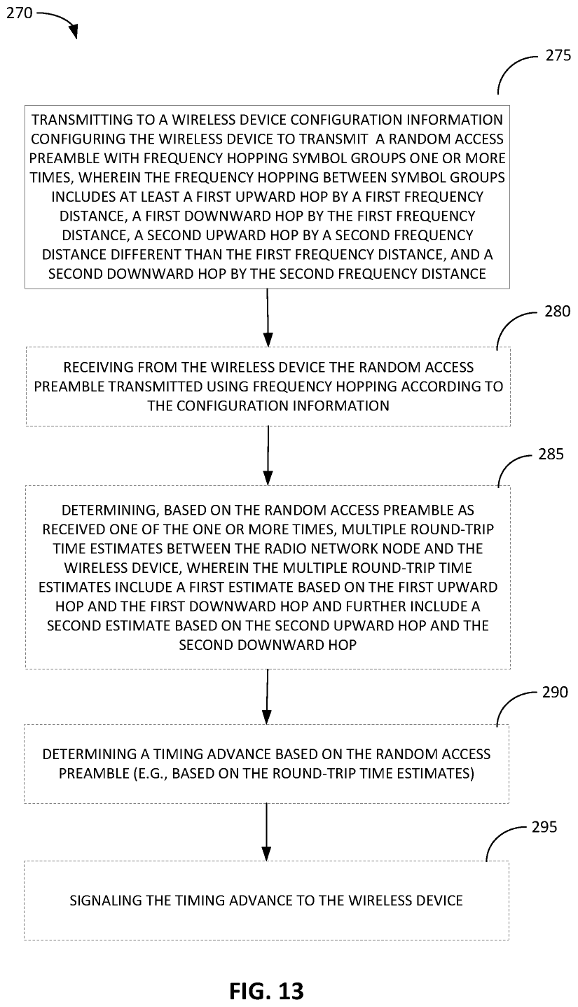

FIG. 13 depicts a method 270 performed by a radio network 12 (e.g., a base station) in accordance with other particular embodiments. The method 270 includes transmitting to a wireless device 14 configuration information that configures the wireless device 14 to transmit a random access preamble with frequency hopping symbol groups 20 one or more times (block 275). The frequency hopping between the symbol groups 20 includes at least a first upward hop by a first frequency distance, a first downward hop by the first frequency distance, a second upward hop by a second frequency distance different than the first frequency distance, and a second downward hop by the second frequency distance. The random access preamble may comprise multiple symbol groups. Each symbol group may comprise a cyclic prefix followed by one or more symbols.

In some embodiments, the method 270 also comprises receiving the random access preamble from the wireless device using frequency hopping according to the configuration information (block 280) and determining, based on the random access preamble as received one of the one or more times, multiple round-trip time estimates between the radio network node and the wireless device (block 285). In one embodiment, for example, the multiple round-trip time estimates include a first estimate based on the first upward hop and the first downward hop and further include a second estimate based on the second upward hop and the second downward hop.

Alternatively or additionally, the method 270 may comprise determining a timing advance based on the random access preamble (e.g., based on the multiple round-trip time estimates) (block 290). The method may also comprise signaling the timing advance to the wireless device (block 295).

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

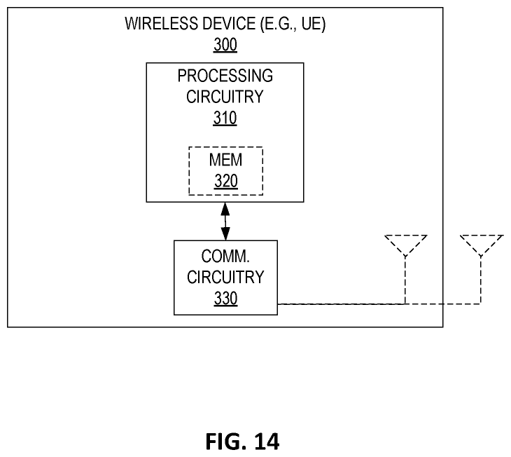

FIG. 14 for example illustrates a wireless device 300 as implemented in accordance with one or more embodiments. As shown, the wireless device 300 includes processing circuitry 310 and communication circuitry 330. The communication circuitry 330 (e.g., radio circuitry) is configured to transmit and/or receive information to and/or from one or more other nodes, e.g., via any communication technology. Such communication may occur via one or more antennas that are either internal or external to the wireless device 300. The processing circuitry 310 is configured to perform processing described above, such as by executing instructions stored in memory 320. The processing circuitry 310 in this regard may implement certain functional means, units, or modules.

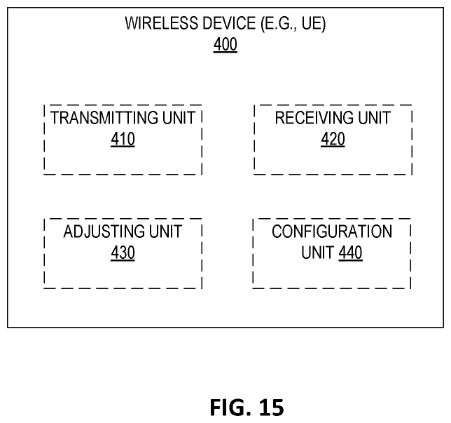

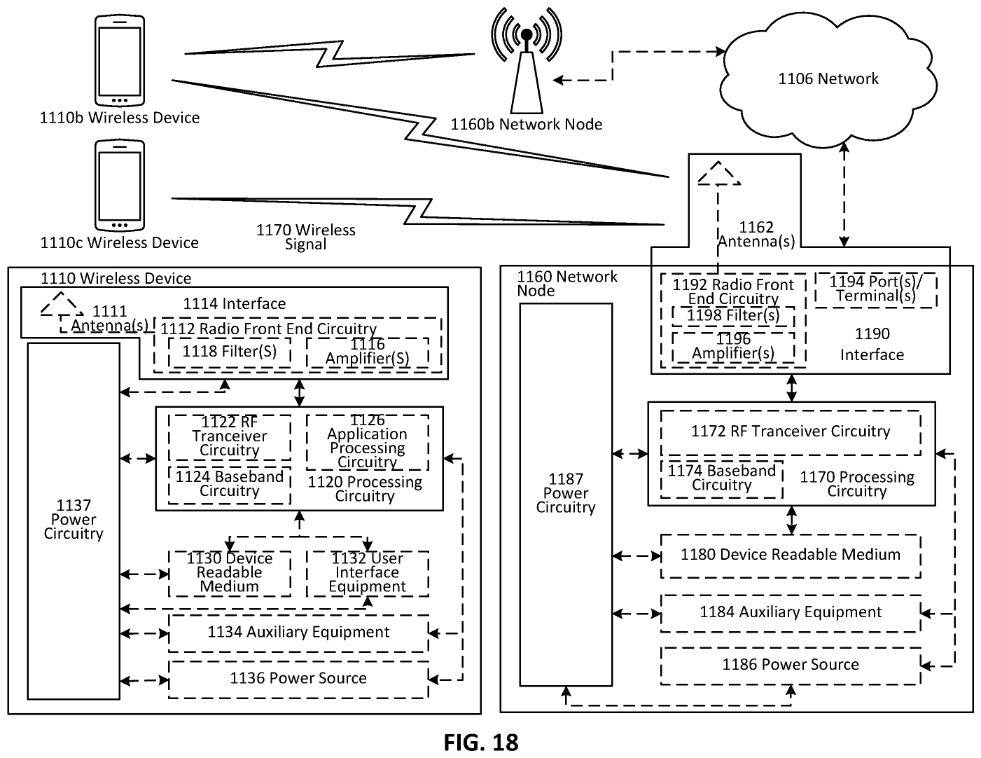

FIG. 15 illustrates a schematic block diagram of a wireless device 400 in a wireless network according to still other embodiments (for example, the wireless network shown in FIG. 18). As shown, the wireless device 400 implements various functional means, units, or modules, e.g., via the processing circuitry 310 in FIG. 14 and/or via software code. These functional means, units, or modules, e.g., for implementing the method(s) herein, include for instance a transmitting unit 410 configured to transmit a random access preamble one or more times using frequency hopping as described above. Also included may be a receiving unit 420 for receiving from a radio network node signaling indicating a timing advance and/or an adjusting unit 430 for adjusting uplink transmission timing of the wireless device based on the timing advance. The wireless device 400 may further include a configuration unit 440 configured to receive configuration information from a radio network node 12. The received configuration information configures the frequency hopping used to transmit the random access preamble.

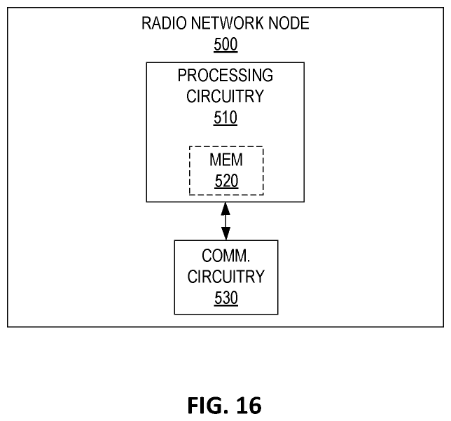

FIG. 16 illustrates a radio network node 500 as implemented in accordance with one or more embodiments. As shown, the network node 500 includes processing circuitry and communication circuitry 530. The communication circuitry 530 is configured to transmit and/or receive information to and/or from one or more other nodes, e.g., via any communication technology. The processing circuitry 510 is configured to perform processing described above, such as by executing instructions stored in memory 520. The processing circuitry 510 in this regard may implement certain functional means, units, or modules.

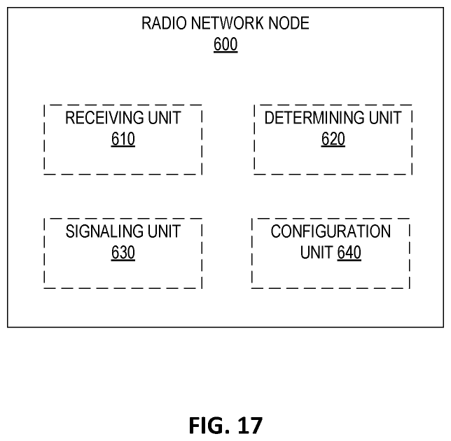

FIG. 17 illustrates a schematic block diagram of a network node 12 in a wireless network according to still other embodiments (for example, the wireless network shown in FIG. 18). As shown, the network node 600 implements various functional means, units, or modules, e.g., via the processing circuitry 510 in FIG. 16 and/or via software code. These functional means, units, or modules, e.g., for implementing the method(s) herein, include for instance a receiving unit 610 for receiving from a wireless device a random access preamble one or more times using frequency hopping as described above. Also included may be a determining unit 620 for determining multiple round-trip time estimates and/or a timing advance as described above. Further included may be a signaling unit 630 for signaling a timing advance to a wireless device as described above. The radio network node 600 may further include a configuration unit 640 configured to transmit configuration information to a wireless device 14 to configure the frequency hopping used by the wireless device 14 to transmit the random access preamble.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 18 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

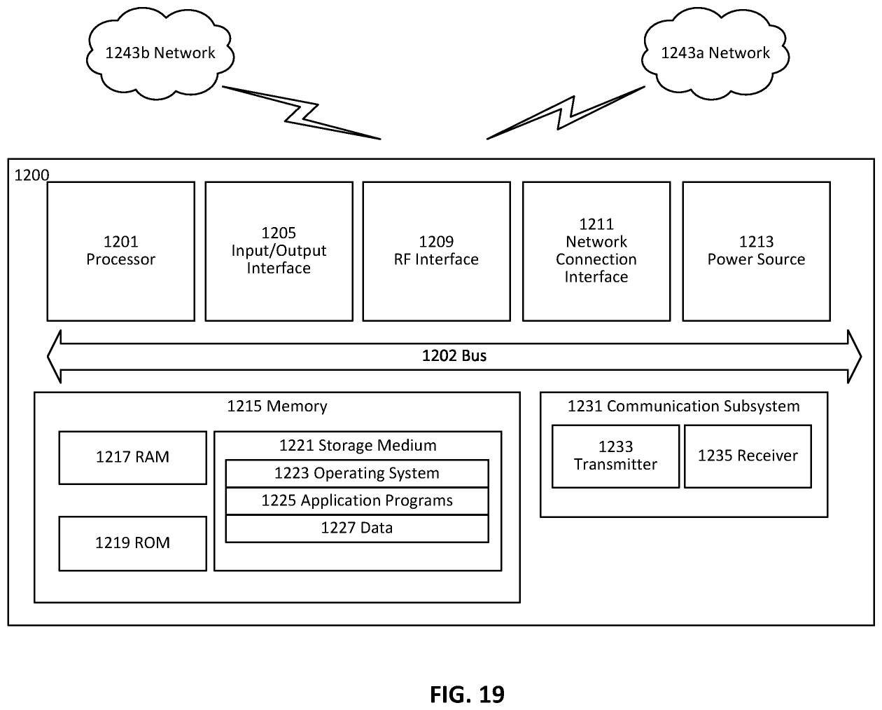

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 19, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 19, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

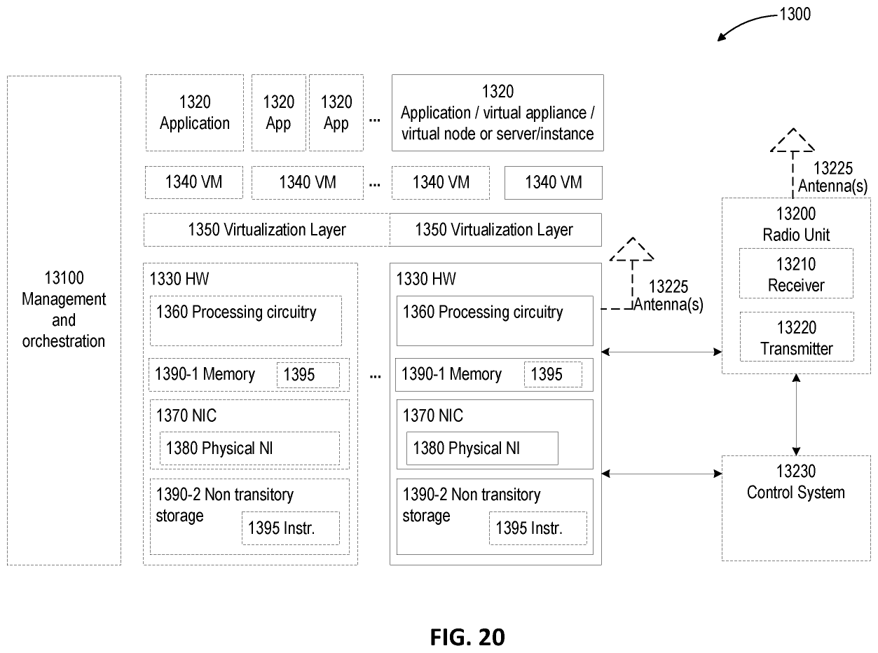

FIG. 20 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 20, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 20.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be effected with the use of control system 13230 which may alternatively be used for communication between the hardware nodes 1330 and radio units 13200.

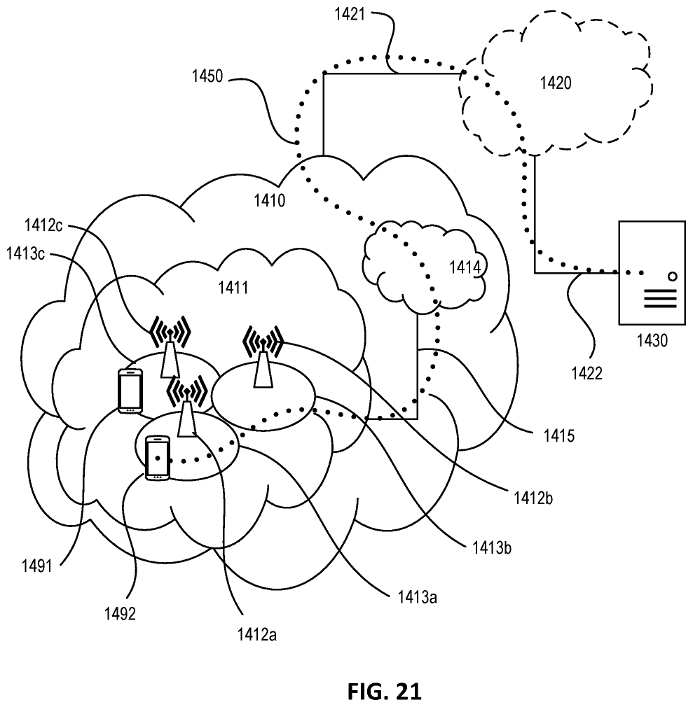

FIG. 21 illustrates a telecommunication network connected via an intermediate network to a host computer in accordance with some embodiments. In particular, with reference to FIG. 21, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1414c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 21 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

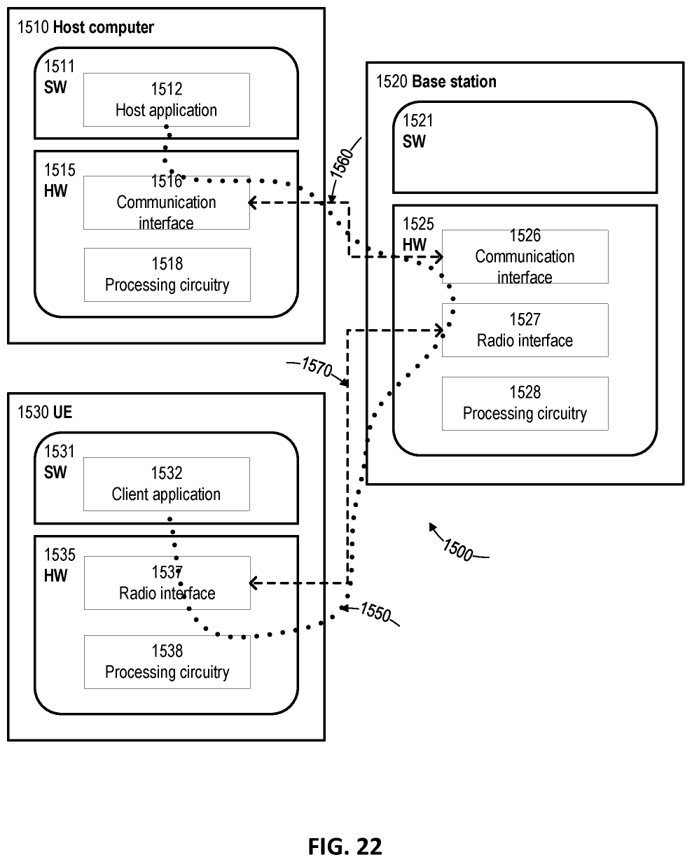

Example implementations, in accordance with an embodiment, of the UE, base station and host computer discussed in the preceding paragraphs will now be described with reference to FIG. 22. FIG. 22 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 22) served by base station 1520. Communication interface 1526 may be configured to facilitate connection 1560 to host computer 1510. Connection 1560 may be direct or it may pass through a core network (not shown in FIG. 22) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 22 may be similar or identical to host computer 1430, one of base stations 1412a, 1412b, 1412c and one of UEs 1491, 1492 of FIG. 21, respectively. This is to say, the inner workings of these entities may be as shown in FIG. 22 and independently, the surrounding network topology may be that of FIG. 21.

In FIG. 22, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve robustness against drifting frequency errors, reduce the time for determining timing advance, and/or reduce the number of preamble repetitions needed for random access and thereby provide benefits such as reduced user waiting time, extended battery lifetime, and better responsiveness.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

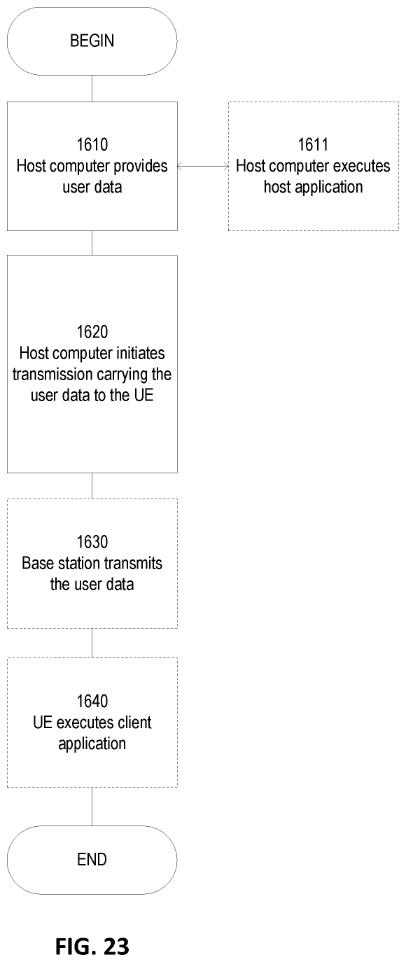

FIG. 23 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 23 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

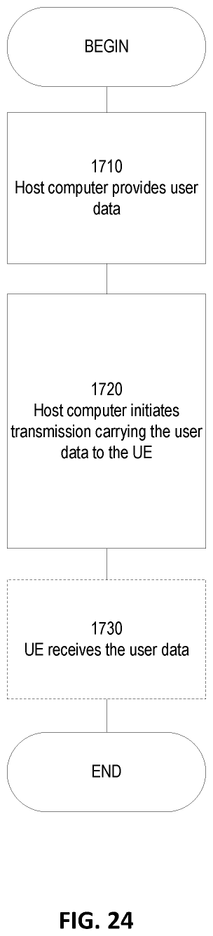

FIG. 24 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 24 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

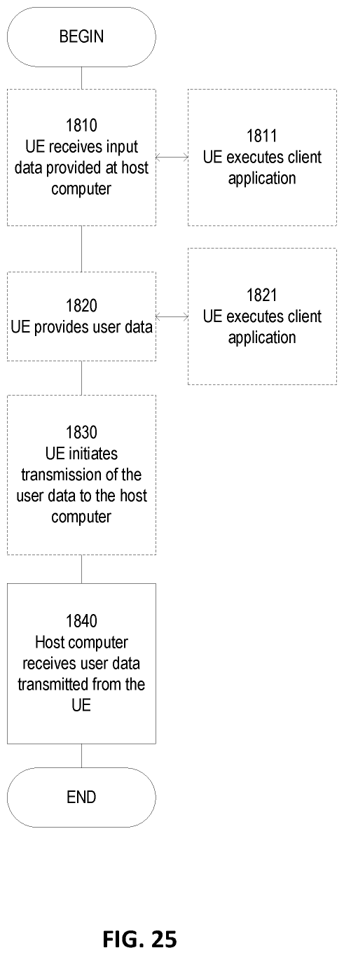

FIG. 25 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 25 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

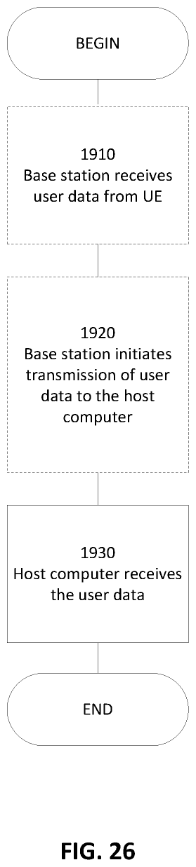

FIG. 26 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 26 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1-54. (canceled)

55. A method performed by a wireless device, the method comprising:
transmitting a random access preamble with frequency hopping symbol groups one or more times;
wherein frequency hopping between the symbol groups includes at least:
a first upward hop by a first frequency distance;
a first downward hop by the first frequency distance;
a second upward hop by a second frequency distance different than the first frequency distance; and
a second downward hop by the second frequency distance;
wherein the random access preamble comprises multiple symbol groups, wherein each symbol group comprises a cyclic prefix followed by one or more symbols.

56. The method of claim 55, wherein the first and second upward hops, and the first and second downward hops, are each a hop between symbol groups that are immediately adjacent in the random access preamble.

57. The method of claim 55, wherein:
the first upward hop by the first frequency distance and the first downward hop by the first frequency distance comprise hops in opposite directions;
the second upward hop by the second frequency distance and the second downward hop by the second frequency distance comprise hops in opposite directions.

58. The method of claim 55, wherein, for each time the random access preamble is transmitted, a frequency distance between a tone index on which transmission of the random access preamble starts and a tone index on which transmission of the random access preamble ends is zero.

59. The method of claim 55, wherein the frequency hopping includes a hop indicated by a pseudo random number that indicates the tone index to be used by any symbol group of the random access preamble.

60. The method of claim 55, wherein the first frequency distance is a distance between the centers of adjacent subcarriers, and the second frequency distance is a distance between the centers of every sixth subcarrier.

61. The method of claim 55, wherein each symbol group comprises a number of identical symbols.

62. The method of claim 55, wherein the first upward hop, the second upward hop, the first downward hop, and/or the second downward hop is a hop between symbol groups that are not immediately adjacent in the random access preamble.

63. A method implemented by a radio network node, the method comprising:
receiving, from a wireless device, a random access preamble with frequency hopping symbol groups one or more times;
wherein the frequency hopping between the symbol groups includes at least:
a first upward hop by a first frequency distance;
a first downward hop by the first frequency distance;
a second upward hop by a second frequency distance different than the first frequency distance; and
a second downward hop by the second frequency distance;
wherein the random access preamble comprises multiple symbol groups, wherein each symbol group comprises one or more symbols.

64. The method of claim 63, wherein the first and second upward hops, and the first and second downward hops, are each a hop between symbol groups that are immediately adjacent in the random access preamble.

65. The method of claim 63, wherein:
the first upward hop by the first frequency distance and the first downward hop by the first frequency distance comprise hops in opposite directions;
the second upward hop by the second frequency distance and the second downward hop by the second frequency distance comprise hops in opposite directions.

66. The method of claim 63, wherein, for each time the random access preamble is received, a frequency distance between a tone index on which reception of the random access preamble starts and a tone index on which reception of the random access preamble ends is zero.

67. The method of claim 63, wherein the frequency hopping includes a hop indicated by a pseudo random number that indicates the tone index to be used for any symbol group of the random access preamble.

68. The method of claim 63, wherein the first frequency distance is a distance between the centers of adjacent subcarriers and the second frequency distance is a distance between the centers of every sixth subcarrier.

69. The method of claim 63, wherein the frequency hopping used to receive the random access preamble each of the one or more times comprises inter-group hopping with each symbol group of the random access preamble received on a respective tone or subcarrier.

70. The method of claim 63, wherein at least one of the first upward hop, the second upward hop, the first downward hop, and the second downward hop is a hop between symbol groups that are not immediately adjacent in the random access preamble.

71. The method of claim 63, further comprising determining a timing advance based on the random access preamble, and signaling the timing advance to the wireless device.

72. The method of claim 63, further comprising:
determining, based on the random access preamble as received one of the one or more times, multiple round-trip time estimates between the radio network node and the wireless device;
wherein the multiple round-trip time estimates include:
a first estimate based on the first upward hop and the first downward hop; and
a second estimate based on the second upward hop and the second downward hop.

73. A wireless device, comprising:
processing circuitry;
memory containing instructions executable by the processing circuitry whereby the wireless device is configured to:
transmit a random access preamble with frequency hopping symbol groups one or more times;
wherein frequency hopping between the symbol groups includes at least:
a first upward hop by a first frequency distance;
a first downward hop by the first frequency distance;
a second upward hop by a second frequency distance different than the first frequency distance; and
a second downward hop by the second frequency distance;
wherein the random access preamble comprises multiple symbol groups, wherein each symbol group comprises a cyclic prefix followed by one or more symbols.

74. A base station, comprising:
processing circuitry;
memory containing instructions executable by the processing circuitry whereby the base station is configured to:
receive, from a wireless device, a random access preamble with frequency hopping symbol groups one or more times;
wherein the frequency hopping between the symbol groups includes at least:
a first upward hop by a first frequency distance;
a first downward hop by the first frequency distance;
a second upward hop by a second frequency distance different than the first frequency distance; and
a second downward hop by the second frequency distance;
wherein the random access preamble comprises multiple symbol groups, wherein each symbol group comprises a cyclic prefix followed by one or more symbols.
